(19) United States
(12) Patent Application Publication
(10) Pub. No.: US 2007/0127494 A1
(43) Pub. Date: Jun. 7, 2007

(54) Method for providing quality of service to a SIP-based device over a communication network

(76) Inventors: Wade Carter, Snellville, GA (US); Bruce McClelland, Alpharetta, GA (US)

Correspondence Address: ARRIS INTERNATIONAL, INC, 3871 LAKEFIELD DRIVE, SUWANEE, GA, 30024, US

(21) Appl. No.: 11/588,056

(22) Filed: Oct. 26, 2006

Related U.S. Application Data
(60) Provisional application No. 60/730,726, filed on Oct. 27, 2005.

(51) Int. Cl. H04L 12/56; H04L 12/28

(52) U.S. Cl. 370/395.21

(57) ABSTRACT

A SIP proxy server embedded in a cable modem or other SIP user device coupled to a cable modem or similar network interface device processes SIP messages associated with SIP communication sessions. The SIP proxy server instructs a QoS manager client, typically also embedded in the cable modem, to communicate with a corresponding QoS manager client at the CMTS. In response to the instruction from the SIP proxy server, the QoS managers cooperate to establish a requested amount of bandwidth to the SIP session. The amount of bandwidth is typically requested in initial SIP set up messaging.

### CROSS REFERENCE TO RELATED APPLICATION

This application priority under 35 U.S.C. 119(e) to Pierce, U.S. provisional patent application No. 60/730,726 entitled “DOCSIS QoS proxy via SIP proxy,” which was filed Oct. 27, 2005, and is incorporated herein by reference in its entirety.

### FIELD OF THE INVENTION

The present invention relates generally to device signaling between devices in a communication network, and more particularly to facilitating SIP-based Quality of Service to SIP devices coupled to a hybrid fiber coaxial cable network.

### BACKGROUND

Cable data systems are used to allow cable TV subscribers use the Hybrid-Fiber-Coax network as a communication link between their home networks and the Internet. As a result, computer information (Internet Protocol packets) can be transmitted across the Hybrid-Fiber-Coax network between home computers and the Internet. The Data Over Cable Service Interface Specification (“DOCSIS”)—defined by CableLabs®—specifies the set of protocols that must be used to effect a data transfer across the Hybrid-Fiber-Coax network (“HFC”). Two fundamental pieces of equipment facilitate this data transfer: a cable modem (“CM”) which is positioned in the subscriber's home, and a Cable Modem Termination System (“CMTS”) which is positioned in the head end of the cable TV company.

In addition to data traffic, subscribers are more and more obtaining telephony voice services over networks other than the traditional public switched telephony network (“PSTN”). A multiple services operator (“MSO”) may provide such telephony services, in addition to data over cable service via DOCSIS. For example, CableLabs has established the PacketCable™ standard for providing telephony services over cable. A subscriber typically has a device that includes a DOCSIS cable modem for transmitting and receiving data and a media terminal adaptor (“MTA”), or embedded MTA (“eMTA”) for processing voice traffic for transmission and reception over cable.

To send and receive telephony/voice calls using a cable modem, a user may couple a traditional telephony device to a subscriber line interface (“SLIC”) jack, typically an RJ-11 jack. The operation of the telephony device coupled in this fashion should be transparent to the user, i.e., it operates as if it were plugged into a traditional RJ-11 telephone jack coupled to the PSTN.

In addition to a standard telephony device being coupled to a cable modem/EMTA, a user device that is designed to send and receive internet protocol (“IP”) packets may be used. Session Initiation Protocol (“SIP”) may be used for call setup signaling. SIP is a protocol that includes logical devices for processing call set up packets, and is designed to operate peer-to-peer with other SIP-based devices. Certain SIP-based devices or logical blocks facilitate traditional PSTN service features, such as, for example, legal interception of calls, emergency calls, such as 911 in United States. Further background information relative to SIP may be found in IETF RFC 3261, entitled “SIP: Session Initiation Protocol,” which may be found at www.ietf.org and is incorporated by reference herein in its entirety.

However, since calls that are set up for operation according to SIP are set up between two or more SIP peers, Quality of Service (“QoS”) levels provided by the MSO are not set up for SIP calls. This may be a problem for SIP calls/sessions that may be used for video conferencing instead of just voice conferencing. Since SIP calls/sessions are designed to be set up between peers, the network and protocol over which calls/sessions are transported, e.g. DOCSIS over HFC or DSL, typically do not receive set up information. For example, even though DOCSIS may be used to carry set-up packets, as well as session traffic packets, over an HFC, the CMTS does not typically process the SIP signaling packets. The CMTS, which typically regulates QoS (i.e. bandwidth) between itself and a cable modem/EMTA device for a given session, does not regulate the bandwidth allocated for a given SIP session. Thus, there is a need in the art for a method and system for providing Quality of Service adjustments of call sessions using session initiation protocol.

### BRIEF DESCRIPTION OF THE DRAWINGS

FIG. 1 illustrates a logic diagram showing distributed applications for facilitating QoS for a SIP-based communication session.

FIG. 2 illustrates a flow diagram of a method for facilitating QoS for a SIP-based communication session.

### DETAILED DESCRIPTION

As a preliminary matter, it will be readily understood by those persons skilled in the art that the present invention is susceptible of broad utility and application. Many methods, embodiments and adaptations other than those herein described, as well as many variations, modifications, and equivalent arrangements, will be apparent from or reasonably suggested by the following description, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

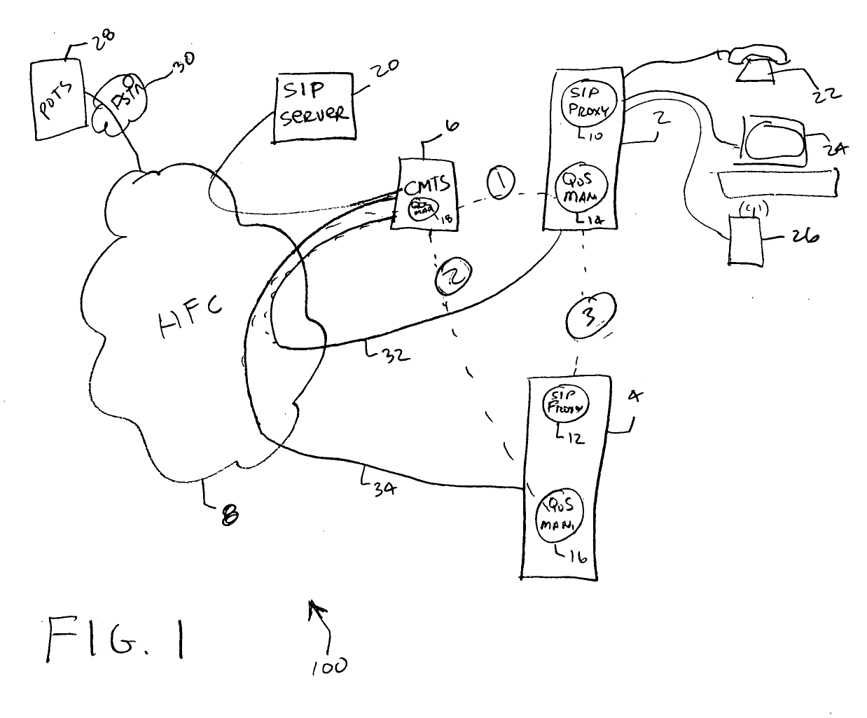

Turning now to the figures, FIG. 1 illustrates a system 100 for facilitating QoS regulation of a communication session with a SIP-based user device. In the embodiment shown, cable modem 2 and cable modem 4 are coupled to CMTS 6 via HFC network 8. Typically, DOCSIS is used to provide transport of signal packets on HFC 8. Cable modems 2 and 4 are shown having SIP proxy servers 10 and 12 respectively, and they are also shown having QoS managers 14 and 16 respectively. Cable modems 2 and 4 contain embedded SIP proxy servers 10 and 12 respectively for facilitating SIP based sessions, typically telephone calls/conferences, video calls/conference or instant messaging sessions, for example. Actual session traffic—the packets containing the voice/video/text information—is transported across HFC 8 according to DOCSIS. In addition, SIP messaging generated by servers 10 and 12 are transported via HFC 8. It will be appreciated that FIG. 1 represents physical coupling of components to one another and HFC 8 as solid lines. FIG. 1 represents logical connections with broken lines.

When a user device coupled to CM 2, is used to place a call, for example, using a SIP phone 22, for example, SIP proxy server 10 ‘invites’, or calls, another device. SIP phone 22 may have appearance that may be familiar to users of conventional telephony devices and that is capable of processing SIP protocol packets for establishing a voice call. It will be appreciated that in addition to telephony-like handset 22, CM 2 may couple to other user devices, including, but not limited to, computer 24 having a SIP interface and/or a SIP wireless device 26. CM 2 invite a call with CM 4, which may have similar devices coupled to it as does CM 2. Alternatively, CM 2 may invite a session with plain old telephony service (“POTS”) device 28 which is shown coupled to HFC 8 via PSTN 30. A PSTN typically couples to CMTS 6 via a gateway device which is not shown in the figure. Additional equipment may be used to process a call/session between HFC 8 and PSTN 30.

CM 2 typically invites another device to join a session by sending an invitation toward the invitee device. SIP proxy server 10 intercepts the invitation message before forwarding it to SIP server 20. SIP server process the invitation and determines how to forward the message to the invited device. In addition to forwarding the SIP invitation message to the invited device after the invitation is intercepted from CM 2, SIP proxy server 10 triggers QoS manager 14 within CM 2 to generate a dynamic service addition (“DSA”) message upon receiving the SIP invitation from server 10. This DSA message is forwarded to QoS manager 18 logically located at CMTS 6. It will be appreciated that encircled proxy servers 10 and 12, and encircled QoS managers 14, 16 and 18 are typically logical clients, or logical ‘devices’ that are operational within their corresponding physical devices, which are represented as rectangular icons in the figure.

Thus, encircled path 1 represents a logical message path from QoS manager 14 to QoS manager. Encircled path 2 represents a similar QoS set-up path between manager 18 and manger 16 if CM device 4 is being invited by CM device 2 join a session. Encircled path 3 represents a logical SIP-based traffic flow between CM device 2 and CM device 4 after a session has been set up there between. It will be appreciated that path 1 delivers set up information to manager 18 so that actual bandwidth on solid link 32 between CMTS 6 and CM 2 is regulated by the CMTS. Similarly, set up information that follows path 2 establishes the amount of bandwidth that CMTS 6 allocates along physical link 34 between CMTS 6 and CM 4. In addition, it will be appreciated that actual message portions, or packets, from managers 14 and 16 at CM 2 and CM 4, respectively, are physically transported to CMTS 6 along physical links 32 and 34, respectively.

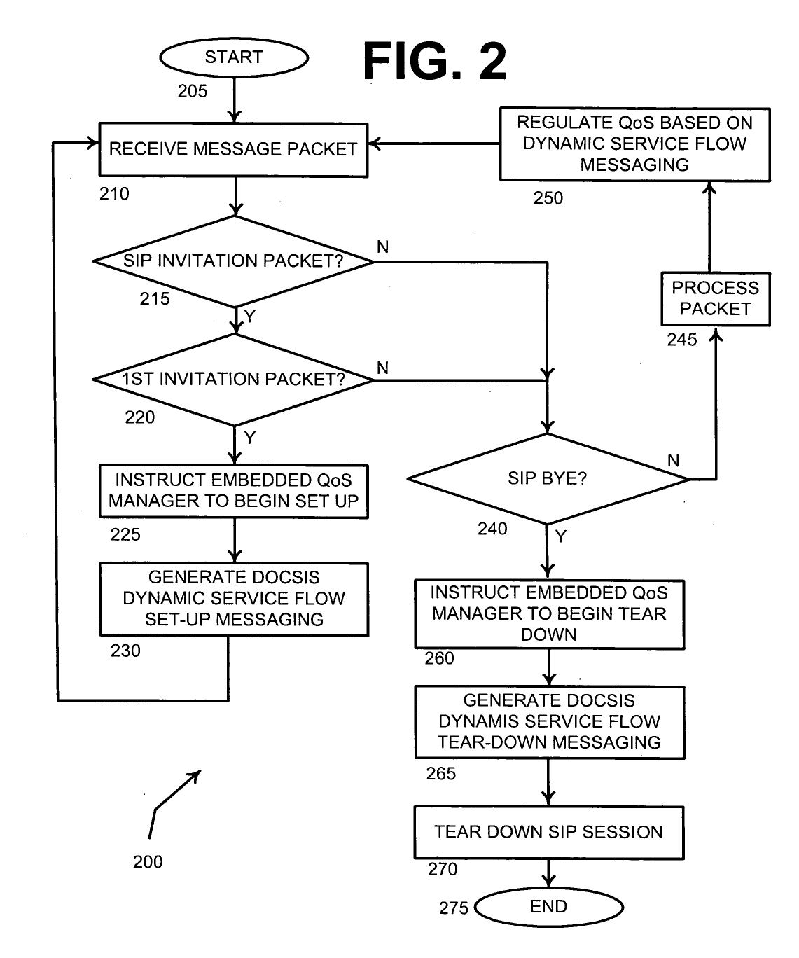

Turning now to FIG. 2 a flow diagram of a method 200 for facilitating QoS for a SIP-based communication session is illustrated. Method 200 starts at step 205. A message packet is received from a SIP client—typically a software application—by a SIP proxy server at a network device, such as a cable modem, at step 210. The proxy server determines at step 215 whether the message portion, or packet, is a SIP invitation message packet. If yes, the SIP proxy server determines at step 220 whether the invitation message packet is the first invitation message packet it has received. If yes, at step 225 the proxy server instructs a QoS manager at the network device to communicate with a QoS manager at a centrally located device, typically a CMTS, to begin setting up the requested amount of bandwidth for a SIP session associated with the invitation to use on a link between the network device and the CMTS. At step 230, DOCSIS dynamic service flow messaging is used to set up the requested amount of bandwidth to be used for SIP session corresponding to the invitation. Method 200 returns to step 210 and receives another packet.

If at step 215 a determination is made that the received packet is not a SIP invitation packet, method 200 advances to step 240. Similarly, if a determination is made at step 220 that an invitation packet being evaluated is not a first invitation packet of a plurality of invitation packets composing a invitation message, method 200 advances to step 240. At step 240, a determination is made whether a packet being evaluated is a SIP BYE packet. If not, the packet is processed and forwarded at step 245. At step 250, transmission of the packet is regulated based on the Dynamic Service Flow Set-up Messaging that was generated at step 230.

After step 250 is performed, another packet is received at step 210. It will be appreciated that when the result of the evaluation at step 220 is ‘N’, performing step 240 before processing the packet at step 245 is extraneous. However, this process flow is shown for clarity in the figure so that the ‘N’ path from step 220 does not cross the ‘N’ path from step 215.

If the result of the evaluation at step 240 is that the packet is a SIP BYE message packet, the SIP proxy server at the cable modem network device instructs the QoS manager at the network device to begin tearing down the bandwidth allocated between the CMTS and the network device for the current session at step 260. At step 265, the QoS manager at the network device causes a Dynamic Service Flow tear-down Message to be generated. The SIP proxy server instructs a SIP server to begin tearing down the SIP session at step 270. The process ends at step 275. It will be appreciated that process 200 applies to regulating the QoS between a given cable modem and its corresponding CMTS. If another SIP device is invited to join a SIP session by a SIP device, method 200 may also be applied to the communication link between the other SIP device and its associated centrally located device, which could be a CMTS, a digital subscriber line access module (“DSLAM”), a wireless router, etc.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for setting a quality of service level for a communication session using a session protocol:
receiving at least one session protocol message portion at a proxy server established in a user device;
processing quality of service level requests at the proxy server established in a user device;
initiating messaging between the user device and a centrally located device based on receiving the at least one session protocol message portion; and
allocating at the centrally located device a quality of service level for the communication session based on the quality of service level request.

2. The method of claim 1 wherein the communication session is a SIP session.

3. The method of claim 1 wherein the proxy server is a SIP proxy server.

4. The method of claim 3 wherein the user device is a cable modem.

5. The method of claim 4 wherein the user device includes an eMTA.

6. The method of claim 1 wherein the centrally located device includes a CMTS.

7. The method of claim 1 wherein the at least one session protocol message portion includes a SIP packet.

8. The method of claim 7 wherein the SIP packet is a SIP signaling messaging packet.

9. The method of claim 7 wherein the SIP packet is a SIP traffic packet.

10. A system for setting a quality of service level for a communication session using a session protocol:
means for processing at least one session protocol message portion at a user device;
means for processing quality of service level requests, coupled to the means for processing at least one session protocol message portion, based on the session protocol message portion processed at the user device by the means for processing at least on session protocol message portion.

11. The system of claim 10 wherein the means for processing quality of service level requests includes means for initiating messaging between the user device and a centrally located device based on receiving the at least one session protocol message portion.

12. The system of claim 10 further comprising means for allocating at the centrally located device a quality of service level for the communication session based on the quality of service level request in response to the messaging initiated by the means for initiating messaging between the user and a centrally located device.

13. The system of claim 10 wherein the means for processing at least one session protocol message portion is a SIP proxy server.

14. The system of claim 10 wherein the means for processing quality of service level requests is a QoS manager.
